(19) United States
(12) Patent Application Publication
(10) Pub. No.: US 2007/0019078 A1
(43) Pub. Date: Jan. 25, 2007

(54) Digital camera loyalty system and method

(75) Inventors: Chi Ping Yeung, Sai Ying Pun (CN); Shui Heung Kwok, Kwun Tong (CN); Ming Kit Leung, Quarry Bay (CN)

Correspondence Address: LERNER GREENBERG STEMER LLP, P O BOX 2480, HOLLYWOOD, FL, 33022-2480, US

(73) Assignee: Concord Camera Corp.

(21) Appl. No.: 11/178,783

(22) Filed: Jul. 11, 2005

(51) Int. Cl. H04N 5/76

(52) U.S. Cl. 348/231.99

(57) ABSTRACT

A digital loyalty camera is provided which includes internal memory or storing digital image files. Additionally, the digital loyalty camera includes a standard interface for transferring the stored image files. In one particular embodiment of the present invention, a standard memory storage card slot is provides as the standard interface for transferring the stored image files. The standard interface is obstructed by a dummy card that is not removable by the consumer. A tool is additionally provided which can be used to remove the dummy card and to access the standard interface. The tool may be provided only to the personnel of a retail outlet affiliated with the digital camera loyalty program, who, using the tool, can remove the dummy card and download the image files in a standard way.

### BACKGROUND OF THE INVENTION

1. Field of the Invention

The invention relates to a digital loyalty camera and a method for recovering the pictures stored on a digital loyalty camera.

2. Description of the Related Art

Retailer loyalty programs are intended to provide incentives to consumers to return to and continue doing business with such retailers. Loyalty programs for film cameras are known. For example, the Assignee of the present invention introduced a film based loyalty system that is the subject of U.S. Pat. No. 6,658,206 to Urs Stampfli, entitled “35 mm promotional camera and a system for promoting consumer loyalty”. Additionally, film cameras are known that require a tool or key to access and/or rewind the film. U.S. Pat. No. 6,862,406 to Franco Yik, assigned to the present assignee, discloses a loyalty camera wherein a particular tool is required to rewind the exposed film and assist in manipulating the film door latch. See also, U.S. Pat. No. 6,490,411 to Mazzacani et al., U.S. Pat. No. 6,325,555 to Zawodny et al., U.S. Pat. No. 5,752,085 to Cloutier et al., U.S. Pat. No. 5,708,856 to Cloutier. CVS Pharmacy, Inc. has recently introduced a digital camera program including a digital one-time-use camera. In the CVS Pharmacy, Inc., system, a digital camera, with or without an LCD display is sold to a consumer. On one side of the CVS digital camera, a label covers a non-standard female connector. A warning label on the camera states:
“To protect your pictures, this sticker should only be removed by a CVS photo specialist.
Camera CANNOT be connected to a computer to download pictures”.

The CVS digital camera has the ability to store a preset number of photographs, in the camera, at a preset level of resolution and quality.

In the CVS digital camera system, the consumer is encouraged to take pictures, which are stored digitally within the camera. The consumer has the ability to delete images stored within the CVS camera, prior to processing. When the consumer wants to print the images stored in the camera, the consumer returns the entire digital camera to a CVS Pharmacy. A store attendant receives the digital camera from the consumer, peels back the label to expose the female connector located therebelow and inserts the entire camera body into specialized equipment located at the pharmacy. The specialized equipment includes a guide channel, which accepts the body of the digital camera, in order to mate the female connector on the camera to a corresponding male connector in the specialized equipment. Each store location participating in the CVS digital camera program must have installed therein the specialized photo-processing equipment including the guide channel and male connector to mate with the digital loyalty camera. Once the camera is mated with the specialized equipment, photographs are printed by the equipment for the consumer, for an additional fee. Further, a photo-CD including digital copies of the photographs is produced and additionally provided to the consumer. The actual digital camera used by the consumer to take the photographs is retained by the attendant.

One disadvantage to a loyalty program having specialized equipment that mates only with one particular digital camera is that the retail location must have additional equipment on site to process photographs taken with standard digital cameras. Additionally, the specialized equipment must be produced and purchased at significant cost and provided to every participating retail location, thus multiplying the cost by the number of retail locations, in addition to the cost of the necessary standard digital picture printing equipment purchased for the retail location. Another disadvantage to the use of specialized equipment is that it takes up space in the retail location, which space could otherwise be used for actual merchandise.

What is needed is a digital camera capable for use with standard digital printing apparatus at a retail location, thereby not requiring any additional proprietary photo-processing equipment. Any such digital camera should include means for deterring the consumer from downloading the digital image files stored therein, but should be easily accessed and downloaded by an attendant located at the retail outlet. What is additionally needed is a digital camera and system that encourages a consumer to revisit a particular retailer.

### SUMMARY OF THE INVENTION

It is accordingly an object of the invention to provide a digital camera loyalty system and method, which overcomes the above-mentioned disadvantages of the heretofore-known devices and methods of this general type.

A digital loyalty camera is provided which includes internal memory for storing digital image files. Additionally, the digital loyalty camera includes a standard interface for transferring the stored image files from the camera's internal memory to the photo processing equipment. In the present invention, the standard interface is rendered inaccessible to the consumer.

In one particular embodiment of the present invention, a standard memory card slot is provided to allow access to the standard interface for transferring the stored image files. A non-recordable (dummy) memory card that is not removable by the consumer is inserted into the card slot. A tool is additionally provided which can be used to remove the dummy card to provide access to the standard interface. The tool may be provided only to the personnel of a retail outlet affiliated with the digital camera loyalty program, who, using the tool, can remove the dummy card, insert a standard, recordable memory card into the card slot and download the image files onto the recordable memory card. The images can then be processed from the second card and prints made, using standard processing equipment.

A method for inexpensively accessing a digital loyalty camera is additionally provided.

Other features which are considered as characteristic for the invention are set forth in the appended claims.

Although the invention is illustrated and described herein as embodied in a digital camera loyalty system and method, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWINGS

FIG. 1 is an isometric view taken from the top-front of a camera that can be used in accordance with the present invention.

FIG. 2 is an isometric view taken from the rear-bottom of a camera in accordance with one embodiment of the present invention.

FIGS. 3A and 3B are isometric views taken from the rear-bottom of a camera engaged with a tool in accordance with one embodiment of the present invention.

FIG. 4 is a perspective view of a tool that can be used in accordance with one embodiment of the present invention.

FIG. 5A is an enlarged front plan view of a dummy card that can be used in connection with one embodiment of the present invention.

FIG. 5B is an enlarged side view of the dummy card of FIG. 5A.

FIG. 5C is an enlarged rear plan view of the dummy card of FIG. 5A.

FIG. 5D is an enlarged isometric view taken from the rear of the dummy card of FIG. 5A.

FIG. 6A is a partial cross-sectional view taken from the bottom side of rear portion of a camera with a dummy card engaged with its memory card slot, in accordance with an embodiment of the present invention.

FIGS. 6B-6E are partial cross-sectional views of rear portion of a camera, as in FIG. 6A, engaged with a tool, in accordance with an embodiment of the present invention.

FIGS. 7A-7C are partial perspective views of a rear portion of a camera engaged with a tool, in accordance with an embodiment of the present invention.

FIG. 8 is a flow diagram of a loyalty method of redeeming the images stored in digital loyalty camera, in accordance with an embodiment of the present invention.

FIG. 9 is a schematic diagram of the storage mechanism internal to a camera in accordance with an embodiment of the present invention.

FIGS. 10A and 10B are flow diagrams of different loyalty methods in accordance with certain embodiments of the present invention.

### DESCRIPTION OF THE PREFERRED EMBODIMENTS

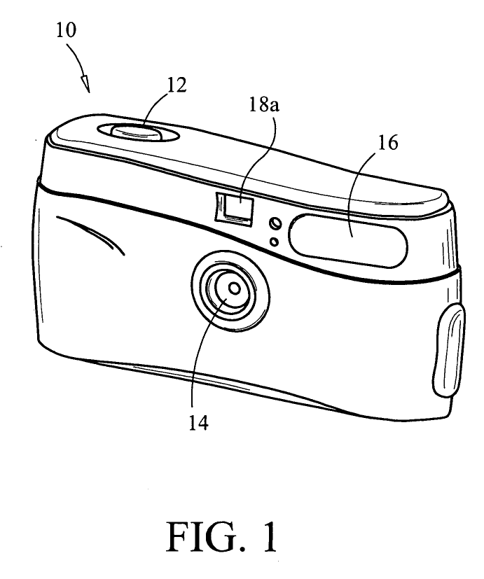

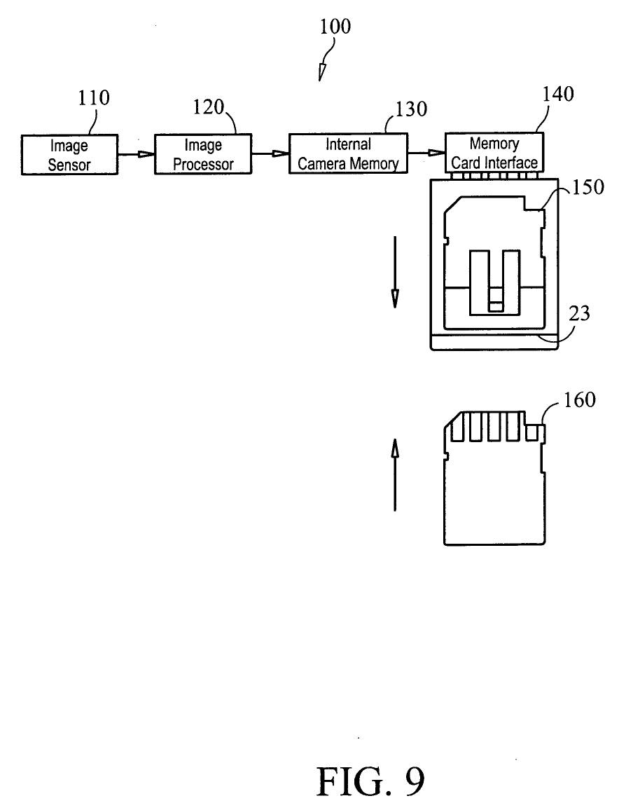

Referring now to the figures of the drawing in detail and first, particularly, to FIG. 1 thereof, there is seen a digital camera 10 which can be used in connection with a loyalty program in accordance with the present invention. The camera 10 includes a lens opening 14 including an optical lens disposed over an image sensor (110 of FIG. 9), which image sensor can be any appropriate resolution. In one particular example, a 2 megapixel sensor can be used. Optionally, a flash window 16 and front optical viewfinder lens 18a may be included. An image capture button 12 extends through the top housing of the camera 10.

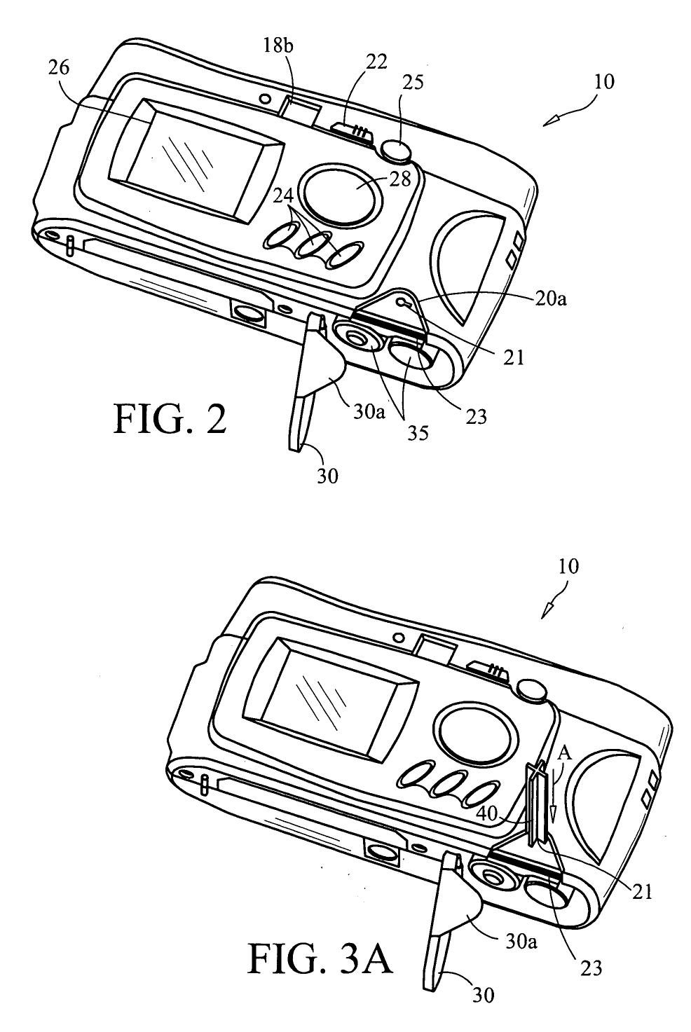

Referring now to FIG. 2, there is shown an isometric view of the camera 10 taken from the rear-bottom, which more particularly shows a battery compartment door 30, which is hingedly fixed to the bottom surface of the camera 10. It should be appreciated that the battery compartment and/or battery compartment door 30 may be disposed at other locations on the camera. The rear face of the camera includes a rear housing 20. The rear housing 20 of the camera 10 can, optionally, include openings for such things as an image review display 26, a power switch 25, a mode switch 22, mode buttons 24 and 28 and/or any other user interface. If a front optical viewfinder lens 18a is included through the front housing of the camera 10, a corresponding rear optical viewfinder lens 18b may be included through the back housing 20 of camera 10.

In the present embodiment of the digital loyalty camera, access to an internal memory card slot 23 is provided through the battery compartment access door 30. Note that this is not meant to be limiting, as access to the memory card slot 23 can be located elsewhere through the housing of the camera 10.

Battery compartment access door 30, when opened by any means (i.e., spring contact, slide and/or tool) exposes a cavity within the camera 10 for receiving the batteries 35. Additionally, a memory card slot 23 is exposed by opening the battery compartment access door 30. In accordance with the present embodiment, the memory card slot 23 is a memory card slot sized to receive a standard memory card, for example, an Secure Digital (SD) memory as made by SanDisk. Note that other types of memory cards are available and can be used with a digital loyalty camera 10, in accordance with the concepts of the present invention.

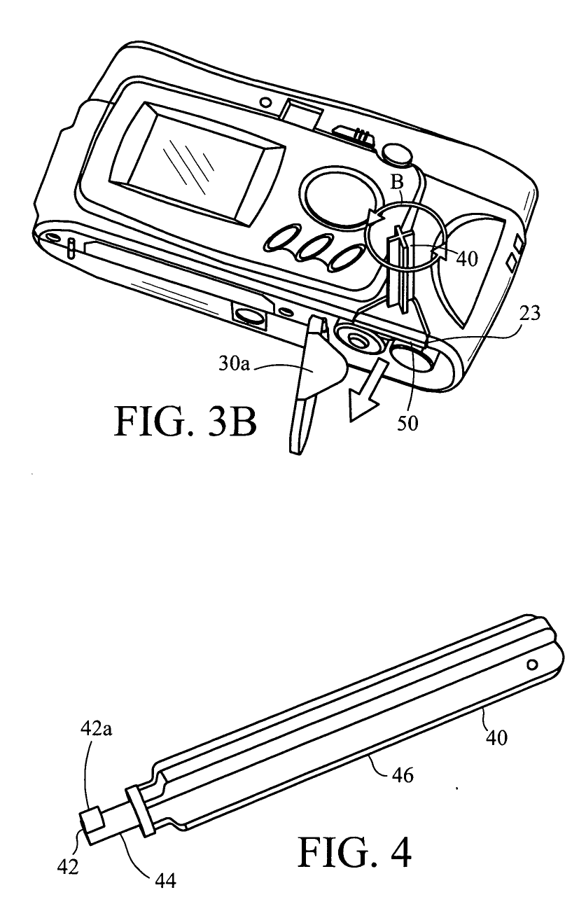

As shown more particularly in FIGS. 2, 3A and 3B, the battery compartment access door 30 optionally includes a flange 30a, which mates with a recess 20a on the rear housing 20 to cover a keyhole 21.

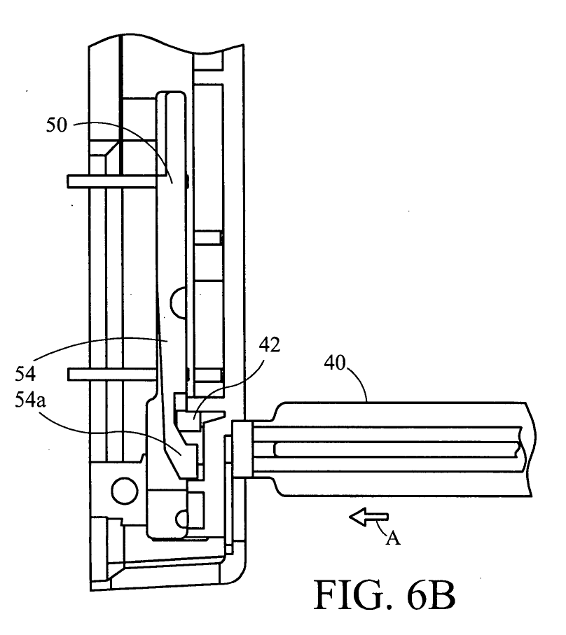

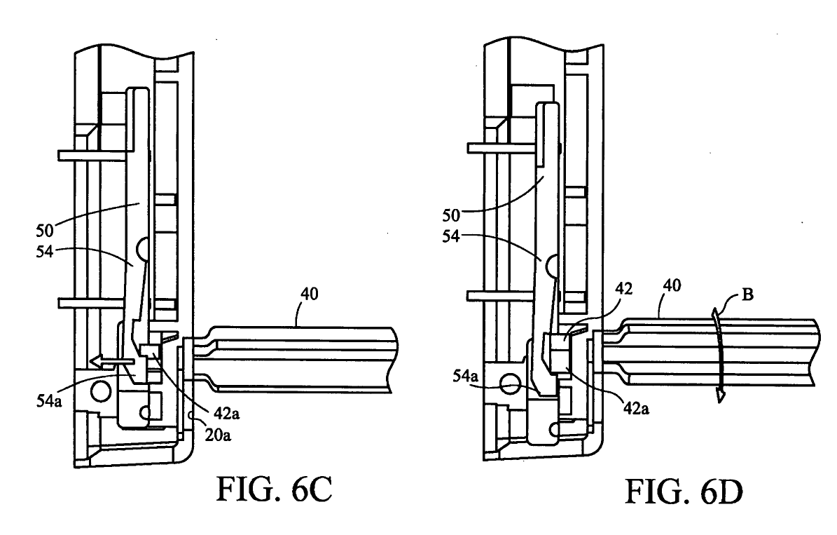

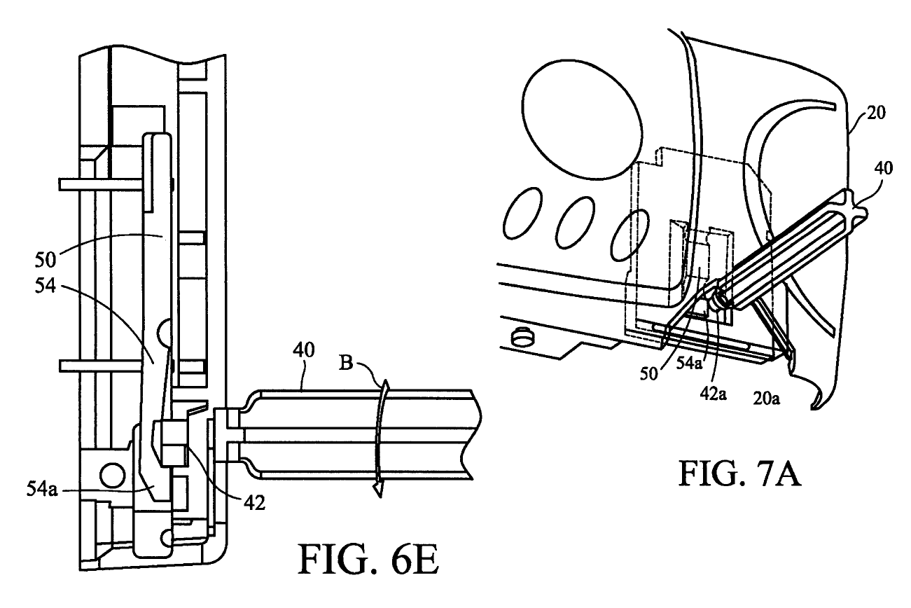

Referring now to FIGS. 2-7, and 9, the keyhole 21 through the rear housing 20 of the camera 10 is sized to receive a key portion 42, including a flange portion 42a of a tool 40. In use, as shown in FIG. 3A, the key portion 42 and part of the shank portion 44 of the tool 40 are aligned with the keyhole 21 and pushed down in the direction of arrow A (FIG. 6B) to admit the flange 42a of the key portion 42 into the housing 20.

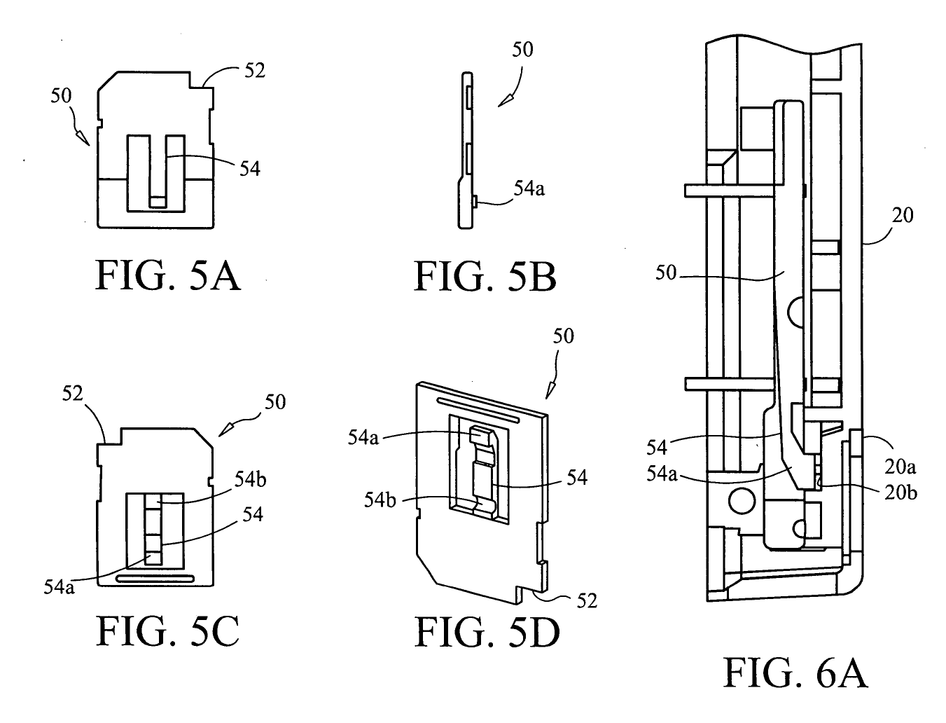

Referring now to FIGS. 5A-7C, the dummy card 50 is shaped generally like the standard memory card which it replaces. However, the dummy card 50 does not have the memory or electronics inherent in the standard memory card (160 of FIG. 9). As such, the dummy card 50 is just a place holder in the memory card slot 23, which prevents the consumer from placing their own memory card 160 into the slot 23. Dummy card 50 includes a spring leg portion 54 integrally formed therewith. The entire dummy card 50 may be made of plastic or some other, suitable material. Spring leg portion 54 includes a projection 54A which, as will be discussed more particularly herebelow, is contacted by the key portion 42 of the tool 40, in order to release the dummy card 50 from the card slot 23. Spring leg portion 54 of the dummy card 50 additionally includes a reduced portion 54b, at the point where the spring leg portion 54 is joined to the body of the dummy card 50. Reduced portion 54b, allows the spring leg portion 54a to flex, when the key portion 42 of the tool 40 engages the projection 54A and applies a bending force to the spring leg portion 54.

Referring now to FIGS. 1-7 and 9, in operation, once the dummy card 50 is slid into the memory card slot 23, the spring leg portion 54 locks the dummy card into the memory slot 23. In the present embodiment, the entire dummy card 23 is enveloped into the memory card slot 23, thus making it difficult for a user to attempt to remove the dummy card 50 by grasping it with the user's fingernails or other article. Because the dummy card 50 is made to resemble a standard memory card 160, the dummy card 50 fits snuggly into the slot 23, making it difficult to jimmy the dummy card 50 out of the slot 23 using an article, such as a paper clip or pin. The dummy card 50 is used to block access to the camera 10's standard communications interface, in the present embodiment, the memory card interface 140.

Additionally, although the dummy card 50 engages the memory card interface 140, there is no electrical contact with the dummy card 50. As such, while the dummy card 50 is entrapped in the memory card slot 23, images present on the image sensor 110 are, when indicated by a signal from the image capture button 12, processed by the image processor 120 and stored in the internal camera memory 130 of the camera 10. Internal camera memory 130 can be chosen to be of any desired size, but in one embodiment, has been chosen to store at least 24 images. In such an embodiment, 16 MB of internal flash memory can be included with the camera 10.

While in the possession of a consumer, images are captured on the digital loyalty camera 10 and automatically stored in the cameras internal camera memory. Note that, in the present invention, the terms images and/or image files are intended to include captured still images, as well as captured digital video image files. Optionally, if an image review display 26 is included on the camera, the consumer may review the captured images and, using the buttons 24, delete any undesired images, replacing them with other captured images.

Once the internal memory 130 of the camera 10 is full, the consumer is prompted to return the camera 10 to the retail outlet affiliated with the digital camera 10 loyalty program. The consumer cannot access the memory card slot 23 and the memory card interface 140 of the camera 10 because the dummy card 50 is configured such that it is not removable from the memory card slot 23 without the use of the tool 40. Additionally, the camera 10 has no direct computer interface that would permit the consumer to download the image files stored in the internal camera memory 130. Accordingly, to obtain prints or digital copies of the images stored on the camera 10, the consumer must return the camera 10 to a retail outlet affiliated with the digital loyalty camera 10 program.

Personnel of the retail outlet affiliated with the digital loyalty camera 10 program will be provided with the tool 40. Once the digital loyalty camera 10 is returned to the retail outlet, personnel at the retail outlet will use the tool 40 to remove the dummy card 50 from the memory card slot 23. As shown in FIG. 6A, the spring leg projection 54a is normally biased by the spring leg 54 into a cavity 20b formed in the interior wall of the camera housing. Thus engaged, the spring leg 54 normally prevents the dummy card 50 from being pried out of the memory card slot 23. It can be seen that a pulling force on the dummy card 50 from the mouth of the slot 23 would be opposed by the spring leg 54 in the cavity 20b.

As shown in FIGS. 3A, 3B and 6A-7C, to remove the dummy card 50 from the memory card slot 23, the key portion 42 of the tool 40 is aligned with and inserted into the key slot 21 of the camera 10 (in the direction of arrow A, as shown in FIG. 6B). Once the key portion 42 and the shank 44 have entered the key slot 21 to the full extent physically permitted, the handle portion 46 of the tool 40 is rotated, in the present example, counter-clockwise (i.e., in the direction of arrow B, as shown in FIG. 6D). Note that this is not meant to be limiting and the present invention would work if it were planned for rotation of the tool 40 in a clockwise direction.

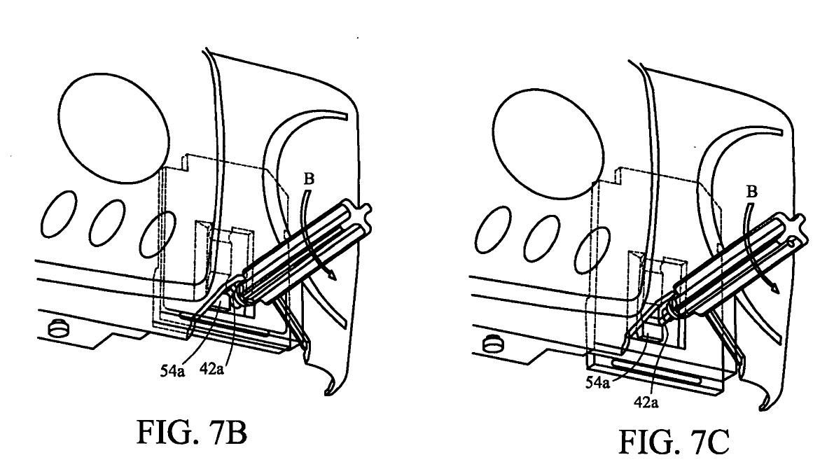

As shown more particularly in FIGS. 6B-7C, as the tool 40 is rotated, the key portion 42 rotates and engages the projection 54a of the spring leg 54, disengaging the spring leg from the cavity 20b of the camera housing and (with a lateral force on the projection 54a caused by contact with a cam surface of the flange 42a of the key portion 42 acting as a cam member) pushing the dummy card 50 so that a portion of the dummy card 50 extends from the slot 23, as shown in FIGS. 6E and 7C. Note that, since the flange 42a acts together with the spring leg projection 54a as a cam mechanism, the amount that the dummy card 50 extends from the memory card slot 23 is proportional to the length of the flange 42a. Optionally, the cam surface of the projection 54a may be curved to complement the curvature of the flange 42a to improve the interaction during the camming operation. An optional groove on the protruding end of the dummy card 50 facilitates the grasping of dummy card 50, which can now be pulled out of the memory card slot 23.

While the preferred embodiment of the present invention discloses the use of a dummy memory card 50, it should be appreciated that other means for preventing the user from gaining access to the memory card slot 23 or memory card interface 140 may, alternatively, be employed.

In accordance with the preferred embodiment of the present invention, once the dummy card 50 has been removed from the slot 23, a standard memory card 160, in the possession of the personnel of the retail outlet, can be easily inserted into and removed from the memory card slot 23. In one embodiment of the present invention, the firmware of the camera 10 can be programmed such that merely inserting the memory card into the memory card slot 23 and turning the camera 10 on will cause the camera firmware to automatically transfer the image files stored in the internal camera memory 130 to the memory card 160. The memory card 160, with all image files stored thereon, can then be removed from the memory card slot 23 by the retail outlet personnel, and the images can be printed and/or written to another form of media, such as a CD-ROM, using standard photoprocessing equipment located in the retail outlet. As such, no special interface or equipment is needed at the retail outlet.

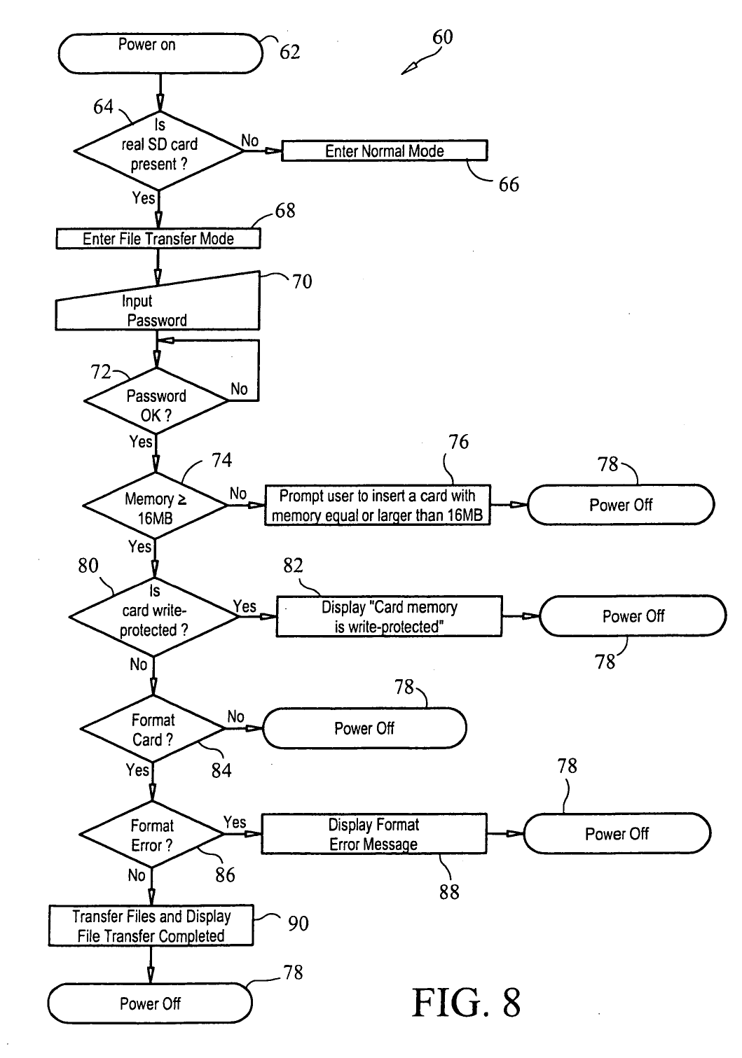

In another embodiment of the present invention, the firmware of the camera 10 may require the input of a password or other proprietary control, using the user interface of the camera 10 in order to transfer the image files stored in the internal camera memory 130 to the standard memory card 160. Referring now to FIG. 8, there is shown a flow diagram 60 for the firmware for one particular embodiment of the camera 10 requiring special inputs to transfer the image files stored in the internal camera memory 130 to the memory card 160. As can be seen, when presented to the personnel at the retail outlet, the camera 10 is first turned on in a proprietary “safe mode” by pressing the power button (25 of FIG. 2) and the menu buttons (24 and/or 28 of FIG. 2), simultaneously. Step 62. On powering up in the safe mode, the camera 10 firmware checks to see if a real memory card 160 is present. Step 64. If no memory card or only the dummy memory card are present, the camera 10 firmware enters its normal operation mode. Step 66.

If the camera 10 is turned on in the “safe mode”, while a real memory card 160 is engaged with the memory card interface 140, the camera 10 enters a file transfer mode. Step 68. In the file transfer mode, the camera can optionally, prompt the user to enter a password, using the camera user interface 24 and 28. Alternatively, the firmware may just await the entry of a password, without prompting the user. Step 70. To ensure security, in one particular embodiment of the invention, the firmware awaits the entry of a 6 digit password. The firmware checks the received password against a password set in the firmware. Step 72. If the proper password is not entered, the camera 10 continues to await entry of the proper password. Alternatively, if after a period of time or a predetermined number of password tries, the correct password is still not entered, the camera 10 can power off, or enter normal operation mode.

If the password entered in step 70 is the correct password, determined in step 72, the firmware checks to ensure that the personnel of the retail outlet has inserted a memory card 160 of a proper size to receive the image files from the internal camera memory 160 (i.e. 16 MB, in one particular example). Step 74. If the memory card 160 is too small, the firmware prompts the retail personnel to insert a card with enough memory. Step 76. The camera may then automatically power off, to permit the retailer to swap the memory cards 160. Step 78. Otherwise, the firmware may permit the memory card 160 to be hot swapped.

If the memory card 160 is sufficient to receive the image files stored on the camera 10's internal camera memory 130, the firmware checks to see if the memory card 160 has been write-protected. Step 80. If so, the firmware of the camera 10 informs the retailer that the inserted memory card 160 is write-protected, via the display 26. Step 80. The camera may then automatically power off, to permit the retailer to swap the memory cards. Step 78.

If the memory card 160 is not write-protected, the camera 10 firmware prompts the retailer to input whether the card should be formatted. Step 84. If the retailer indicates that the memory card 160 should not be formatted, the camera may then automatically power off, to permit the retailer to swap the memory cards. Step 78. If the retailer concurs with the request to format the memory card 160, the firmware of camera 10 proceeds to format the memory card 160. If an error is encountered while formatting the memory card 160, an error message may be displayed to the retailer. Step 88. The camera 10 may then automatically power off, to permit the retailer to swap the memory cards 160. Step 78.

If the memory card 160 formats without an error, the image files stored in the internal camera memory 130 are transferred to the formatted memory card 160 and a “file transfer completed” message is displayed to alert the retailer that it is now safe to remove the memory card 160 from the memory card slot 23. Step 90. After which, the camera 10 firmware may, optionally turn the camera off. Step 78. Upon writing the digital image files to the memory card 160, the firmware of the camera 10 may delete the images from the internal camera memory 130.

As noted above, once the image files have been transferred from the internal camera memory 130 to the memory card 160, the retailer may use standard processing equipment to read the image files from the memory card 160 and print the pictures. The standard equipment may additionally be used to burn a photo-CD containing the digital image files (i.e., still or video) for the consumer.

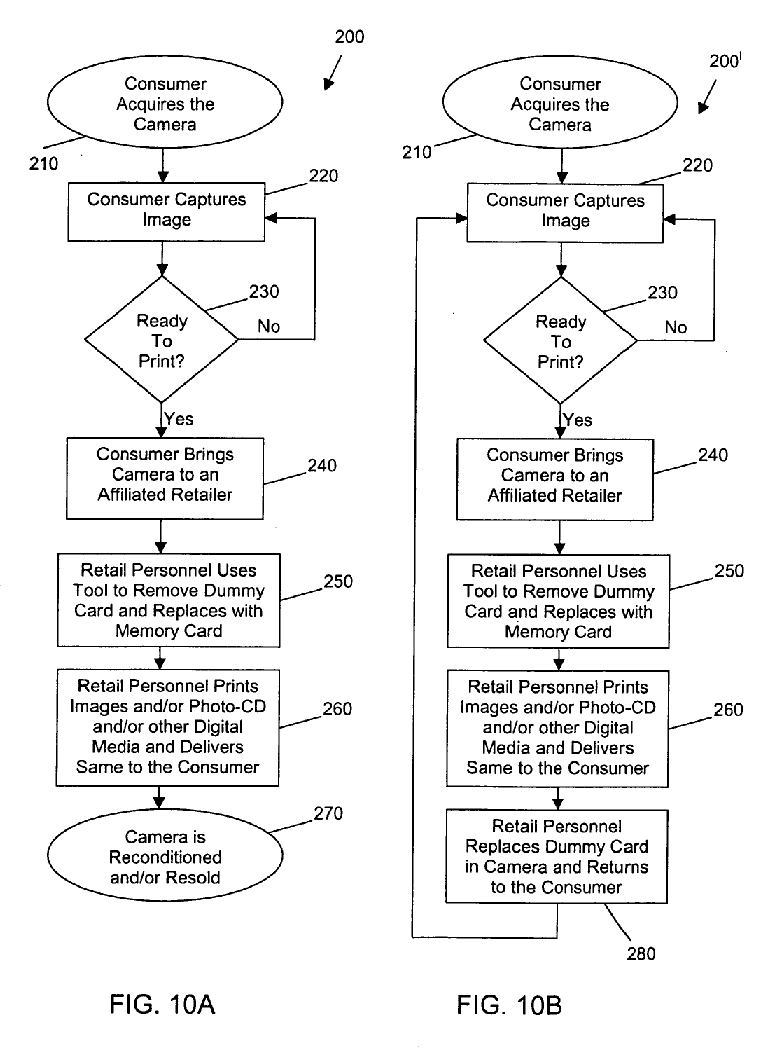

In a first digital camera loyalty method 200 of the present invention illustrated in FIG. 10A, the consumer acquires the digital loyalty camera 10 (step 210) from the retailer for a fee, or at no cost, and pays an additional fee for the printing of the images and/or burning of the photo-CD. The consumer takes photos with the camera 10. Step 220. As noted above, if a review mechanism is provided on the camera 10, the consumer may review the pictures and delete undesired photos, until either the camera memory is full, or the consumer is otherwise ready to retrieve the images from the camera 10. Step 230. The camera is returned to an affiliated retail outlet (step 240) and the retail personnel accesses the digital image files, for example, by the above described methods of using the tool 40 to remove the dummy card and transferring the image files to a standard memory card. Step 250. The pictures and/or a photo-CD are then delivered to the consumer. Step 260. In such an embodiment, the digital camera may be retained by the retailer after the pictures are delivered to the consumer. Such digital camera can then be reconditioned and/or resold to another consumer with the dummy card 50 locked into the memory card slot 23. Step 270. It should be appreciated that the retailer may either: (i) charge a fee to the consumer when the consumer acquires the camera 10, which fee will also cover the cost of processing and printing the images; (ii) provide the camera 10 to the consumer free of charge with the expectation that the consumer will the pay the retailer for processing and printing the images; or (iii) charge the consumer a fee when the consumer acquires the camera 10 and to process and print the pictures.

In a second digital camera loyalty method 200′ illustrated in FIG. 10B, the consumer may buy the digital loyalty camera 10 (step 210) outright, for perhaps a higher price than in the previous method 200, with ownership of the camera 10 remaining with the consumer. As in the previous embodiment, the consumer takes photos until the internal camera memory is full, or the consumer is otherwise ready to retrieve the images stored therein. Step 230. The consumer brings that camera 10 to the retailer (step 240) and personnel of the retailer retrieves the image files (step 250) and prints the photos and/or a photo-CD in the retailers standard mini-lab or print station. The retailer delivers the prints and/or photo-CD to the consumer. Step 260. In the second loyalty method 200′, after the images are processed and printed, the retailer returns the camera 10 to the consumer with the dummy card 50 replaced in the memory slot 23 (step 280), leaving the consumer free to take more pictures (step 220) and, again, return the camera to the retail outlet. Optionally, such method can further be enhanced by a promotional additive, such as by offering a free photo-CD to the consumer, each time they pay for the physical prints.

The above embodiments are described in connection with a dummy card entrapped in a standard memory card slot. Note however that, in another embodiment of the present invention, it would be possible to engage a dummy plug with a different type of standard interface, for example, a standard USB interface on the camera, instead of a memory card slot. It can be seen how, if the plug were fabricated to fit the standard USB port seamlessly, it would require a tool, such as tool 40 to remove. In such an embodiment, a tool could be used to remove the plug, and the image files could be downloaded to the mini-labs using existing photo-processing equipment, via the standard USB interface. It should also be appreciated that the dummy card or dummy plug concept may be used with digital cameras having any other means for retrieving images from the camera.

While the invention has been described with reference to certain embodiments, it will be understood by those skilled in the art that various changes may be made and equivalents may be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method for retrieving images taken by a consumer with a digital camera, comprising the steps of:
(a) providing a digital camera to the consumer, said digital camera including an internal memory for storing captured image files and an interface for transferring said captured image files from said internal memory, wherein access to said said interface is blocked by an article;
(b) receiving said digital camera back from the consumer;
(c) removing said article to unblock access to said interface, after step (b);
(d) transferring said captured image files from said internal memory to a device, via said interface, after step (c); and
(e) providing said image files to the consumer embodied in a tangible medium.

2. The method of claim 1, wherein a specialized tool is required to remove said article.

3. The method of claim 1, wherein said device is a removable memory card.

4. The method of claim 1, wherein said interface includes a memory card interface, accessible via a memory card slot.

5. The method of claim 4, wherein said article comprises a dummy card.

6. The method of claim 5, wherein said dummy card is structured to prevent removal by the consumer.

7. The method of claim 6, wherein said dummy card includes a spring leg interacting with a portion of said memory card slot to entrap said dummy card in said memory card slot.

8. The method of claim 7, wherein said camera includes a housing containing said memory card slot, said housing including a keyhole therethrough aligned with a portion of said memory slot, and wherein said method further includes the step of providing a specialized tool for removing said dummy card, said specialized tool includes a key portion corresponding to said keyhole, wherein said key portion of said specialized tool is passed through said key hole to disengage said spring leg from said memory card slot.

9. The method of claim 8, wherein said key portion includes a flange that interacts with a portion of said spring leg, to push a portion of said dummy card out of said memory card slot.

10. The method of claim 1, further comprising the steps of:
(f) replacing said article to reblock access to said interface; and
(g) returning said digital camera to the consumer, after step (f).

11. The method of claim 5, further comprising the steps of:
(f) replacing said article to reblock access to said interface; and
(g) returning said digital camera to the consumer, after step (f).

12. The method of claim 1, wherein said tangible medium includes at least one of photo prints and a computer readable medium including at least said digital image file.

13. The method of claim 12, wherein said computer readable medium includes a photo-cd.

14. A digital camera, comprising:
a camera housing;
an image capture mechanism, enveloped by said camera housing, for capturing an image and preparing an image file therefrom;
an internal memory for storing at least said image file;
an interface physically accessible from an opening through said camera housing, said interface for transferring image files stored in said internal memory; and
an article blocking access to said interface from outside said camera housing.

15. The digital camera of claim 14, wherein said interface includes a memory card interface, accessible via a memory card slot, an opening of which extends through said camera housing.

16. The digital camera of claim 15, wherein said article includes a dummy card contained in said memory card slot, to block access to said memory card interface.

17. The digital camera of claim 16, wherein said dummy card includes a spring leg interacting with a portion of said memory card slot to entrap said dummy card in said memory card slot.

18. The digital camera of claim 17, wherein said camera includes a housing containing said memory card slot, said housing including a keyhole therethrough aligned with a portion of said memory slot, said keyhole adapted to engage a portion of a specialized tool corresponding to said keyhole, said keyhole being aligned with a portion of said spring leg such that passage of a portion of the specialized tool through said keyhole would disengage said spring leg from said memory card slot.

19. A digital camera system, comprising:
a digital camera, including:
a camera housing;
an image capture mechanism, enveloped by said camera housing, for capturing an image and preparing an image file therefrom;
an internal memory for storing at least said digital image file;
an interface accessible from an opening through said camera housing structured to transfer image files stored in said internal memory;
an article blocking access to said interface from outside said camera housing.

20. The digital camera system of claim 19, wherein said article requires a specialized tool to remove from said opening and wherein said digital camera system further includes said specialized tool adapted to engage said article for removal of said article from said opening.

21. The digital camera system of claim 20, wherein said interface includes a memory card interface, accessible via a memory card slot, an opening of which extends through said camera housing.

22. The digital camera system of claim 21, wherein said article includes a dummy card contained in said memory card slot, blocking access to said memory card interface.

23. The digital camera system of claim 22, wherein said dummy card includes a spring leg interacting with a portion of said memory card slot to entrap said dummy card in said memory card slot.

24. The digital camera system of claim 23, wherein said specialized tool includes a key portion and wherein said camera includes a housing containing said memory card slot, said housing including a keyhole therethrough aligned with a portion of said memory slot, said keyhole adapted to engage said key portion of said specialized tool, said keyhole being aligned with a portion of said spring leg such that passage of said key portion through said keyhole disengages said spring leg from said memory card slot.

25. The digital camera system of claim 24, wherein said key portion includes a flange that interacts with a portion of said spring leg, to push a portion of said dummy card out of said memory card slot.
